(19) United States
(12) Patent Application Publication
(10) Pub. No.: US 2005/0215319 A1
(43) Pub. Date: Sep. 29, 2005

(54) METHOD AND APPARATUS FOR CONTROLLING A THREE-DIMENSIONAL CHARACTER IN A THREE-DIMENSIONAL GAMING ENVIRONMENT

(75) Inventors: Alexander P. Rigopulos, Watertown, MA (US); Eran B. Egozy, Cambridge, MA (US); Dan Schmidt, Boston, MA (US); Eric Metois, Arlington, MA (US); Greg Lopiccolo, Brookline, MA (US)

Correspondence Address: LAHIVE & COCKFIELD, LLP., 28 STATE STREET, BOSTON, MA, 02109, US

(73) Assignee: HARMONIX MUSIC SYSTEMS, INC., Cambridge, MA (US)

(21) Appl. No.: 10/710,628

(22) Filed: Jul. 26, 2004

Related U.S. Application Data
(60) Provisional application No. 60/521,263, filed on Mar. 23, 2004.

(51) Int. Cl. A63F 13/00

(52) U.S. Cl. 463/32

(57) ABSTRACT

A method for allowing a player of a video game to control a three-dimensional game character in a three-dimensional game world includes the steps of acquiring video image data of a player of a game, analyzing the acquired video image data to identify the location or movement of a portion of the player's body; and using the identified location of the portion of the player's body to control behavior of a game character.

### CROSS REFERENCE TO RELATED APPLICATIONS

This application claims priority to U.S. Ser. No. 60/521,263, filed Mar. 23, 2004, the contents of which are incorporated herein by reference.

### FIELD OF THE INVENTION

The present invention relates generally to computer gaming technology and, more particularly, to techniques and apparatus for controlling the movement and behavior of a three-dimensional character in a video game without use of a traditional game controller.

### BACKGROUND OF THE INVENTION

Since their introduction, video games have become increasingly visually sophisticated. In a typical modern video game, players control the movement and behavior of game characters that appear to be three-dimensional. Game players navigate these characters through three-dimensional environments to position a character at a particular location in the environment, solve problems posed by, or discover secrets hidden in, the environment, and engage other characters that may be controlled either by the game engine or by another game player. Despite increasingly realistic worlds and increasingly realistic effects on the environment caused by the character, user input to these games is still limited to input sequences that a game player can generate entirely with fingers and thumbs through manipulation a gamepad, ajoystick, or keys on a computer keyboard.

Perhaps because of the inherent limitation of these traditional input devices, other input devices have begun to appear. A particular example is a camera manufactured by Sony Corporation for the PlayStation 2 game console and sold under the tradename EyeToy. This peripheral input device has enabled a number of “camera-based” video games, such as the twelve “mini-games” shipped by Sony Corporation for the PlayStation 2 under the tradename EyeToy:Play. In each of the twelve mini-games included on EyeToy:Play, an image of the game player is displayed on screen and the player engages in gameplay by having his image collide with game items on the screen. However, these games suffer from the drawback that, since a video image of the player is inherently “flat,” these games are typically restricted to comparatively shallow and simplistic two-dimensional gameplay. Further, since these games directly display the image of the game player on the screen, game play is limited to actions the game player can physically perform.

### BRIEF SUMMARY OF THE INVENTION

The present invention provides a game player with the ability to control the behavior or movement of a three-dimensional character in a three-dimensional environment using the player's entire body. The methods of controlling character movement or behavior may be, therefore, more natural, since if a game player wants to raise the character's left hand, the player simply raises his own left hand. Further, these methods require more physical engagement on the part of the game player than traditional methods for controlling a character since game character movement or behavior is controlled by more than the player's fingers.

In one aspect the present invention relates to a method for allowing a player of a video game to control a three-dimensional game character in a three-dimensional game world. Video image data of a player of a game is acquired, the acquired video image data is analyzed to identify the location of a portion of the player's body, and the identified location of the portion of the player's body is used to control behavior of a game character.

In some embodiments, the acquired video image data is analyzed to identify the location of the player's head. In some of these embodiments, the acquired video image data is analyzed to additionally identify the location of the player's hands, the location of the player's feet, the location of the player's torso, the location of the player's legs, or the location of the player's arms. In certain of these embodiments, the game character is steered in a rightward direction when the player's head leans to the right and the game character is steered to the left when the player's head leans to the left. In others of these certain embodiments, the game character is steered in an upward direction when the player's head is raised or lowered, and in a downward direction when the player's head is raised or lowered. In still others of these certain embodiments, the game character crouches when the player's head is lowered and assumes an erect position when the player's head is raised. In still further of these certain embodiments, the game character jumps when the player's head rises rapidly. In yet further of these certain embodiments, the game character to the left when the player's head leans to the left and the game character leans to the right when the player's head leans to the right. In more of these certain embodiments, the game character accelerates when the player's head is lowered and decelerates when the player's head is raised.

In other embodiments, the visual image data is analyzed to identify the location of the player's hands. In some of these embodiments, the visual image data is analyzed to also identify the location of the player's feet, the location of the player's torso, the location of the player's legs, or the location of the player's arms. In certain of these embodiments, the game character decelerates when the player's hands are outstretched in front of the player, the game character's left hand raises when the player's left hand is raised, and the game character's right raises hand when the player's right hand is raised. In still other of these embodiments, the game character accelerates when the distance between the game player's body and hand decreases and decelerates when the distance between the game player's body and hand increases. In still further of these embodiments, the game character turns to the left when the distance between the player's left hand and body increases and turns to the right when the distance between the player's right hand and body increases.

In still other embodiments, the visual image data is analyzed to identify the location of the player's feet. In some of these embodiments, the visual image data is analyzed to also identify the location of the player's torso, the location of the player's legs, or the location of the player's arms.

In further other embodiments, the visual image data is analyzed to identify the location of the player's torso. In some of these further embodiments, the visual image data is analyzed to identify the location of the player's legs or the location of the player's arms.

In still further other embodiments, the visual image data is analyzed to identify the location of the player's legs. In some of these embodiments, the visual image data is analyzed to also identify the location of the player's arms.

In yet further embodiments, the video image data is analyzed to determine a gesture made by the player, which is used to control the game character, such as by spinning the game character clockwise in response to the gesture or by spinning the game character counter-clockwise in response to the gesture.

In another aspect, the present invention relates to a system for allowing a player of a video game to control a three-dimensional game character in a three-dimensional game world. An image acquisition subsystem acquires video image data of a player of a game. An analysis engine identifies the location of a portion of the player's body. A translation engine uses the identified location of the portion of the player's body to control behavior of a game character.

In some embodiments, analysis engine identifies the location of the player's head. In further of these embodiments, the analysis engine identifies the location of the player's head, the location of the player's feet, the location of the player's torso, the location of the player's legs, or the location of the player's arms. In still further of these embodiments, the translation engine outputs signals indicative of: steering a game character in a rightward direction when the player's head leans to the right, steering a game character in a leftward direction when the player's head leans to the left, steering a game character in an upward direction when the player's head is raised, steering a game character in a upward direction when the player's head is lowered, steering a game character in a downward direction when the player's head is raised, steering a game character in a downward direction when the player's head is lowered, causing a game character to crouch when the player's head is lowered, causing a game character to assume an erect position when the player's head is raised, causing a game character to jump when the player's head rises rapidly, leaning a game character to the left when the player's head leans to the left, leaning a game character to the right when the player's head leans to the right, accelerating a game character when the player's head is lowered, or decelerating a game character when the player's head is raised.

In other embodiments, the analysis engine identifies the location of the player's hands. In further other embodiments, the analysis engine identifies the location of the player's feet, the location of the player's torso, the location of the player's legs, or the location of the player's arms. In still further of these other embodiments, the translation engine outputs signals indicative of: decelerating a game character when the player's hands are outstretched in front of the player, decelerating a game character when the player's hands are held away from the player's body, raising a game character's left hand when the player's left hand is raised, raising a game character's right hand when the player's right hand is raised, accelerating a game character when the distance between the game player's body and hand decreases, decelerating a game character when the distance between the game player's body and hand increases, turning a game character to the left when the distance between the player's left hand and body increases, or turning a game character to the right when the distance between the player's right hand and body increases.

In still other embodiments, the analysis engine identifies the location of the player's feet. In more of these other embodiments the analysis engine identifies the location of the player's torso, the location of the player's arms, or the location of the player's legs.

In yet other embodiments, the analysis engine identifies the location of the player's torso. In further of these yet other embodiments, the analysis engine identifies the location of the player's arms, or the location of the player's legs.

In yet further embodiments, the analysis engine identifies the location of the player's arms.

In still yet further embodiments, the analysis engine identifies the location of the player's legs.

In yet more embodiments, the analysis engine determines a gesture made by the player. In these yet more embodiments, the translation engine outputs signals indicative for controlling the game character responsive to the determined gesture, such as spinning the game character clockwise in response to the gesture or spinning the game character counter-clockwise in response to the gesture.

### BRIEF DESCRIPTION OF THE DRAWINGS

These and other aspects of this invention will be readily apparent from the detailed description below and the appended drawings, which are meant to illustrate and not to limit the invention, and in which:

FIG. 1A is a block diagram of one embodiment of a system that allows a game player to control the behavior and movement of a three-dimensional character in a three-dimensional gaming environment;

FIG. 1B is a block diagram of one embodiment of a networked system that allows multiple game players to control the behavior and movement of respective three-dimensional characters in a three-dimensional gaming environment;

FIG. 2 is a flowchart depicting one embodiment of the operation of a system that allows a game player to control the behavior and movement of a three-dimensional character in a three-dimensional gaming environment;

FIG. 3 is a diagrammatic representation of one embodiment of an apparatus that allows a game player to control the behavior and movement of a three-dimensional character in a three-dimensional gaming environment;

FIGS. 4A and 4B are block diagrams depicting embodiments of computer systems useful in connection with the present invention.

### DETAILED DESCRIPTION OF THE INVENTION

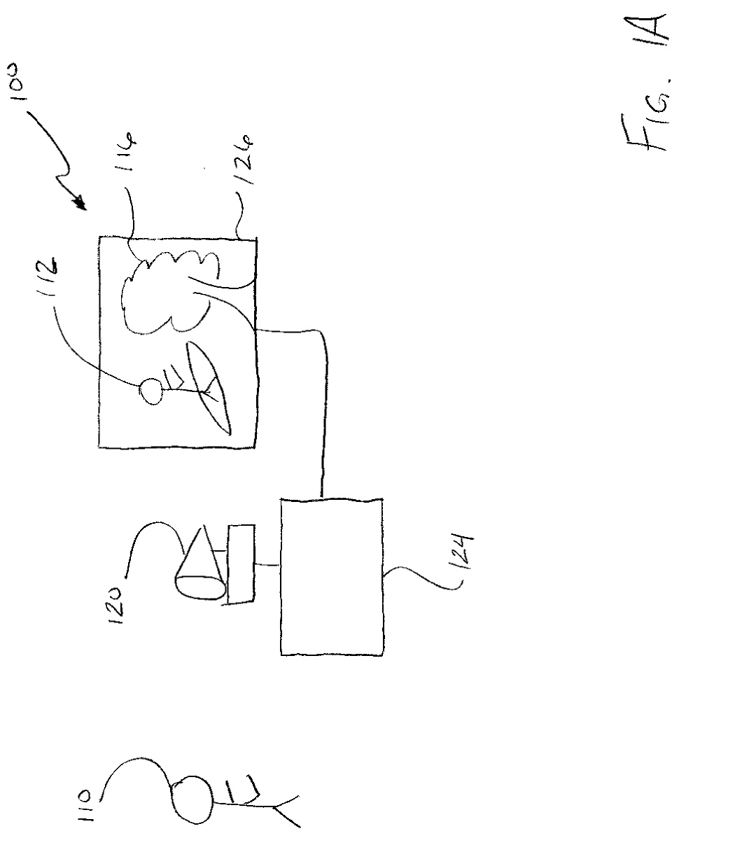

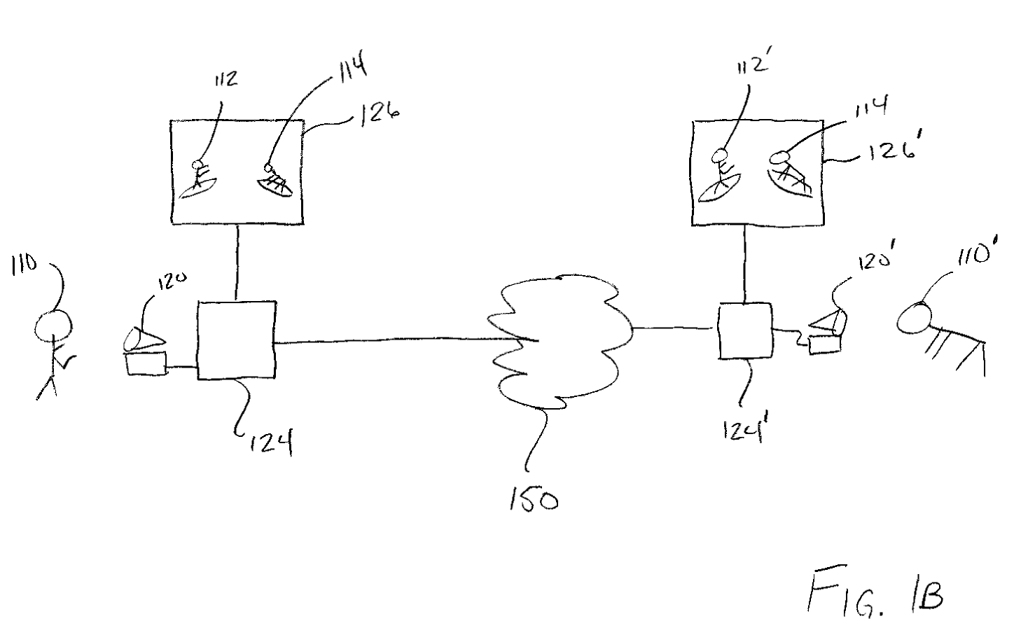

Referring now to FIG. 1A, one embodiment of a system 100 according to the present invention is shown. The embodiment shown in FIG. 1A includes a camera 120 for capturing video image data of a game player 110. The camera 120 is in electrical communication with a game platform 124. The game platform produces visual display data on a display screen 126. Behavior and movement of a three-dimensional character 112 in a three-dimensional gaming environment is controlled by the game player using the system 100. Although much of the discussion below will refer to games that are played for amusement, the systems and methods and described in this document are equally applicable to systems for providing training exercises, such as simulated battle conditions for soldiers or simulated firefight conditions for police officers, as well as games that facilitate exercise and fitness training.

The game platform 124 may be a personal computer such as any one of a number of machines manufactured by Dell Corporation of Round Rock, Tex., the Hewlett-Packard Corporation of Palo Alto, Calif., or Apple Computer of Cupertino, Calif. In other embodiments the game platform 124 is a console gaming platform, such as GameCube, manufactured by Nintendo Corp. of Japan, PlayStation 2, manufactured by Sony Corporation of Japan, or Xbox, manufactured by Microsoft Corporation of Redmond, Wash. In still other embodiments, the game platform is a portable device, such as GameBoy Advance, manufactured by Nintendo or the N-Gage, manufactured by Nokia Corporation of Finland.

As shown in FIG. 1A, the game platform 124 is in electrical communication with a camera 120. Although shown in FIG. 1A separate from the game platform 124, the camera 120 may be affixed to, or a unitary part of, the game platform 124. The camera 120 may use a charge-coupled device array to capture digital image information about the game player 110, i.e., the camera 120 is a digital camera. In these embodiments, the camera 120 may be an EyeToy, manufactured by Sony Corporation of Tokyo, Japan. For embodiments in which the game platform 124 is a personal computer, the camera may be an iSight camera, manufactured by Apple Computer of Cupertino, Calif. In alternative embodiments, the camera 120 captures visual image data in analog form. In these embodiments, the game platform 124 digitizes the captured visual data.

In some embodiments of the invention the camera 120 is replaced by another device or devices for sensing the location or movement of parts of the game player's body. For example, the system may replace the camera 120 with one or more electromagnetic sensors, such as the PATRIOT line of electromagnetic sensors, manufactured by Polhemus, of Colchester, Vt. In these embodiments, the sensors may be associated with various parts of the game player's body to be tracked and the system 100 receives and processes input from the sensors as will be described below. In other embodiments the camera 120 may operate on frequencies outside the visual range. In these embodiments, the camera 120 may be a sensing device that relies on radio waves, such as a global positioning system (GPS) transceiver or a radar transceiver. In other embodiments, the camera 120 may use energy at Terahertz frequencies. In still other embodiments, the camera 120 may operate in the infrared domain.

The game platform 124 is in electrical communication with a display device 126. Although shown separate from the game platform in FIG. 1A, the display device 126 may be affixed to, or a unitary part of, the game platform 124. For example, the N-Gage and GameBoy Advance units have built-in display screens 126. The game platform 126 produces display data representing a game environment. As shown in FIG. 1A, the game platform 124 displays a game environment that includes a game character 112 and a game element 116 with which the player 110 can make the character 112 interact.

FIG. 1B depicts a system in which two game players 110, 110′ interact with each other via the interaction of their respective game characters 112, 112′ in the game environment. Each player 110, 100′ has a game platform 124, 124′ that includes a camera 120, 120′ and a display screen 126, 126′. The game platforms 124, 124′ communicate via network 150. The network 150 can be a local area network (LAN), a metropolitan area network (MAN), or a wide area network (WAN) such as the Internet. The game platforms 124, 124′ may connect to the network 150 through a variety of connections including standard telephone lines, LAN or WAN links (e.g., T1, T3, 56 kb, X.25), broadband connections (ISDN, Frame Relay, ATM), and wireless connections (GSM, CDMA, W-CDMA). Connections between the game platforms 124, 124′ may use a variety of data-link layer communication protocols (e.g., TCP/IP, IPX, SPX, NetBIOS, NetBEUI, SMB, Ethernet, ARCNET, Fiber Distributed Data Interface (FDDI), RS232, IEEE 802.11, IEEE 802.11a, IEE 802.11b, IEEE 802.11g and direct asynchronous connections).

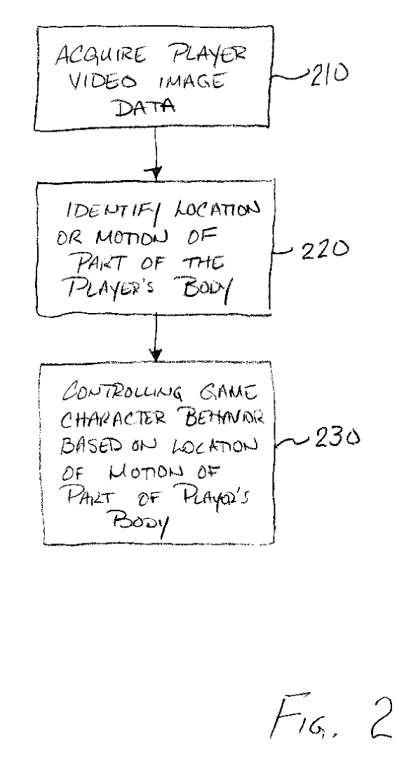

Referring now to FIG. 2, one embodiment of the operation of a system that allows a game player to control the behavior and movement of a three-dimensional character in a three-dimensional gaming environment is shown. In brief overview, the method includes the steps of: acquiring video image data of the player (step 210); identifying the location or motion of at least a portion of the player's body (step 220); and controlling the behavior or movement of a game character responsive to the identified location or motion of at least a portion of the player's body (step 230).

Still referring to FIG. 2 and in greater detail, the first step is to acquire video image data representing the player. The video image data may be acquired with any frequency necessary to acquire player data. In some embodiments, the camera 120 acquires 60 frames of visual image data per second. In other embodiments, the camera 120 acquires 30 frames of visual image data every second. In still other embodiments, the camera acquires 24 frames of visual image data per second. In still other embodiments the camera acquires 15 frames of visual image data per second. In still further embodiments, the number of frames of visual data per second the camera acquires varies. For example, the camera 120 may decrease the number of frames of visual data acquired per second when there is very little activity on the part of the game player. The camera may also increase the number of frames of visual image data acquire per second when there is rapid activity on the part of the game player.

The acquired video image data is analyzed to identify the location or motion of at least a part of the player's body (step 220). In one embodiment, identification of the location or motion of parts of the player's body is facilitated by requiring the game player to wear apparel of a specific color to which the software is calibrated. By locating the color in the video frame, the software tracks the relative location of a specific portion of the player's body. For example, in one embodiment, the player wears gloves of a specific color. The software tracks the location of the player's hands by locating two clusters of the specific color in the video frame. This concept can be extended to bracelets, shoes, socks, belts, headbands, shirts, pins, brooches, earrings, necklaces, hats, or other items that can be affixed to the player's body. The analysis engine may identify the game player's head, eyes, nose, mouth, neck, shoulders, arms, elbows, forearms, upper arm, hands, fingers, chest, stomach, waist, hips, legs, knees, thighs, shins, ankles, feet, or toes.

In further embodiments, the player may wear a first indicator having a first color, such as gloves of a first color, and a second indicator having a second color, such as a headband of a second color. In these embodiments, the analysis engine uses the described color matching technique to track multiple parts of the player's body.

In another embodiment, the location or movement of the player's head may be tracked using a pattern matching technique. In these embodiments, a reference pattern representing the player's face is captured during a calibration phase and that captured pattern is compared to acquired visual image data to determine where in the frame of acquired visual data a match occurs. Alternatively, any one of a variety of well-known techniques for performing facial pattern recognition may be used.

In still other embodiments, the game platform 124 uses other well-established means, such as more sophisticated pattern recognition techniques for identifying the location and movement of the player's body. In still other embodiments, a chromakey technique is used and the player is required to stand in front of a colored screen. The game platform software isolates the player's body shape and then analyzes that shape to find hands, head, etc.

In still further embodiments, no colored screen is used. Instead the video image of the player is compared to a “snapshot” of the background scene acquired before the player entered the scene in order to identify video pixels different from the background to identify the player's silhouette, a technique known as “background subtraction.” Yet another technique is to analyze the shapes and trajectories of frame-to-frame difference pixels to ascertain probable body parts or gestures. Any such means of acquiring information about the location of specific body parts of the player is consistent with the present invention.

The techniques described above may be used in tandem to track multiple parts of the game player's body. For example, the analysis engine may track the game player's head, hands, feet, torso, legs, and arms. Any combination of any number of these parts may be tracked simultaneously, that is, the analysis engine may track: head, hands, feet, torso, legs, arms, head and hands, head and feet, head and torso, head and legs, head and arms, hands and feet, hands and torso, hands and legs, hands and arms, feet and torso, feet and legs, feet and arms, torso and legs, torso and arms, legs and arms, head and hands and feet, head and hands and torso, head and hands and legs, head and hands and arms, head and feet and torso, head and feet and legs, head and feet and arms, head and torso and legs, head and torso and arms, head and legs and arms, hands and feet and torso, hands and feet and legs, hands and feet and arms, hands and torso and legs, hands and torso and arms, hands and legs and arms, feet and torso and legs, feet and torso and arms, feet and legs and arms, torso and legs and arms, head and hands and feet and torso, head and hands and feet and arms, head and hands and feet and legs, head and hands and torso and arms, head and hands and torso and legs, head and hands and arms and legs, head and feet and torso and arms, head and feet and torso and legs, head and torso and arms and legs, hands and feet and torso and arms, hands and feet and torso and legs, feet and torso and arms and legs, head and hands and feet and torso and arms, head and hands and feet and torso and legs, head and feet and torso and arms and legs, head and hands and feet and torso and arms and legs.

This concept may be extended to nearly any number of points or parts of the game player's body, such as: hands, eyes, nose, mouth, neck, torso, shoulders, arms, elbows, forearms, upper arm, hands, fingers, chest, stomach, waist, hips, legs, knees, thighs, shins, ankles, feet, and toes. In general, any number of parts of the player's body in any combination may be tracked.

However the location or motion of the player's body is determined, that information is used to control the behavior or movement of a game character (step 230). A large number of game character behaviors may be indicated by the location or movement of a part of the game player's body. For example, the motion of the player's hands may directly control motion of the character's hands. Raising the player's hands can cause the associated character to assume an erect position. Lowering the player's hands can cause the associated character to assume a crouched position. Leaning the player's hands to the left can cause the associated character lean to the left or, alternatively, to the right. In some embodiments, leaning the player's hands to the left or right also causes the associated character to turn to the left or right. Similarly, motion of the player's hands may directly control motion of the character's hands and motion of the player's feet may directly control motion of the character's feet. That is, motion of hands and feet by the game player may “marionette” the game character, i.e., the hands and feet of the game character do what the hands and feet of the game player do.

The location or movement of various parts of the game player's body may also control a number of game character motions. In some embodiments, the player's hands cause “drag” to be experienced by the associated game character, slowing the velocity with which the game character navigates through the game environment. In some of these embodiments, the further the player's hands are positioned from the player's body, the more drag is experienced by the player's game character and the faster the velocity of the game character decreases. Extension of the player's hands in a direction may cause the game character to slow its progress through the game environment. In some of these embodiments, extension of the player's hands above the player's hands causes deceleration of the game character. In others of these embodiments, extension of the player's hands in front of the player causes deceleration of the game character.

In still other embodiments, the player's head position may control the speed with which a game character moves through the game environment. For example, lowering the player's head (i.e., crouching) may cause the game character to accelerate in a forward direction. Conversely, raising the player's head (i.e., assuming an erect position) may cause the game character to decelerate. The player's vertical posture may control the character's vertical navigation in the game environment (e.g. crouching steers in an upward direction and standing steers in a downward direction, or vice versa). The player's entire body leaning may cause the character's entire body to lean in the same, or the opposite, direction. A rapid vertical displacement of the player's head may trigger a jump on the game character's part.

In other embodiments, gestures made by the game player can trigger complex motions on the character's part. For example, the game player sweeping both arms clockwise may cause the game character to execute a spin (i.e. rotation about the axis running from the hands to the feet of the game character) in a clockwise direction and sweeping arms counter-clockwise may cause the game character to execute a spin in a counter-clockwise direction, or vice versa. In another embodiment, raising the player's arms causes the game character to execute a forward, or backward, tumble (i.e. rotation about an axis from the left side of the game character's body to the right side of the game character's body). In another embodiment, lowering the player's hands causes the game character to execute a forward, or backward, tumble. In still other embodiments, raising the game player's left arm while lowering the game player's right arm will cause the game character to roll (i.e., rotation about an axis from the front of the game character's body to the rear of the game character's body) in a counter-clockwise direction, or vice versa. In another embodiment, raising the game player's right arm while lowering the game player's left arm will cause the game character to roll clockwise, or vice versa.

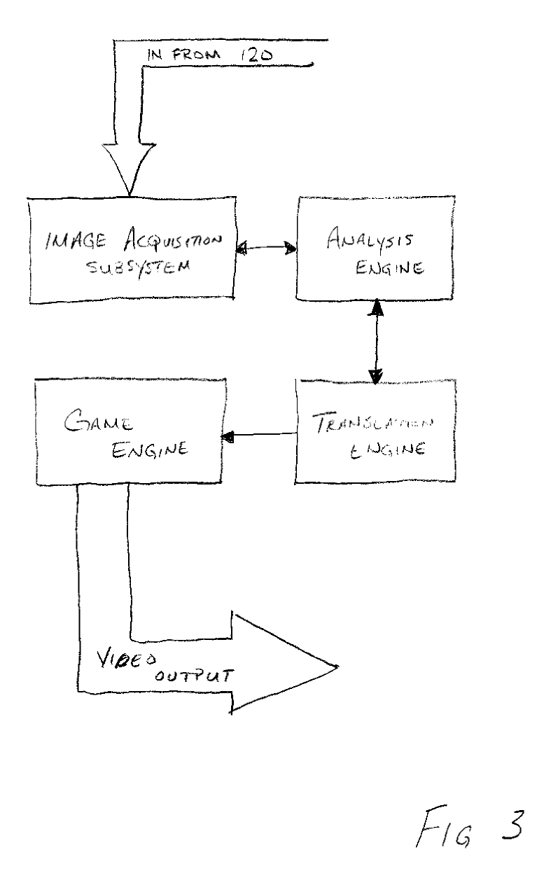

FIG. 3 depicts a block diagram of one embodiment the respective portions of a game platform capable of performing the steps described above. In brief overview, the game platform includes an image acquisition subsystem 310, a video image analysis engine 320 in communication with the image acquisition subsystem 310, a translation engine 330 in communication with the analysis engine 320 and a game engine 340.

The image acquisition subsystem 310 acquires and stores video image data in digital format. In some embodiments, the image acquisition subsystem 310 includes a digitizer, which accepts analog video data and produces digital video image data. In other embodiments, the image acquisition subsystem 310 receives video data in digital form. In either case, the image acquisition subsystem stores the video data in a portion of random access memory that will be referred to in this document as a frame buffer. In some embodiments, the image acquisition subsystem may include multiple frame buffers, i.e., multiple blocks of memory capable of storing a fully captured image.

The analysis engine 320 is in electrical communication with the image acquisition subsystem, in particular with the video data stored by the image acquisition subsystem 310 in its frame buffers. The analysis engine 320 retrieves video image data recorded by the image acquisition subsystem 310 and identifies one or more portions of a player's body as described above in connection with FIG. 2. The analysis engine 320 may also identify one or more gestures made by the game player, such as raising one's arms overhands, waving both hands, extending one or both hands, jumping, lifting one foot, kicking, etc.

The translation engine 330 converts the information concerning the location and movement of the game player's body into one or more actions to be performed by the game character associated with the game player. That information is provided to the game engine 340, which integrates that information with information concerning the remainder of the game, i.e., other game elements, to produce a stream of visual game-related data for display on a display device 126.

In many embodiments, the image acquisition subsystem 310, the analysis engine 329, the translation engine 330, and the game engine 340 may be provided as one or more application-specific integrated circuits (ASICs), field-programmable gate arrays (FPGAs), programmable logic devices (PLDs), or assorted “glue logic,” interconnected by one or more proprietary data busses. For embodiments in which the game platform is provided by a personal computer system the respective functions of the image acquisition subsystem 310, the analysis engine 320, the translation engine 330 and the game engine 340, may be provided by software processes executed by the computer's central processing unit.

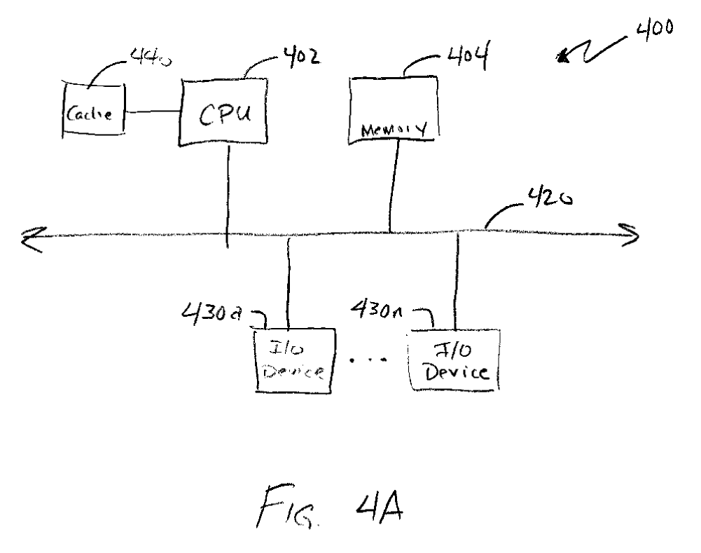

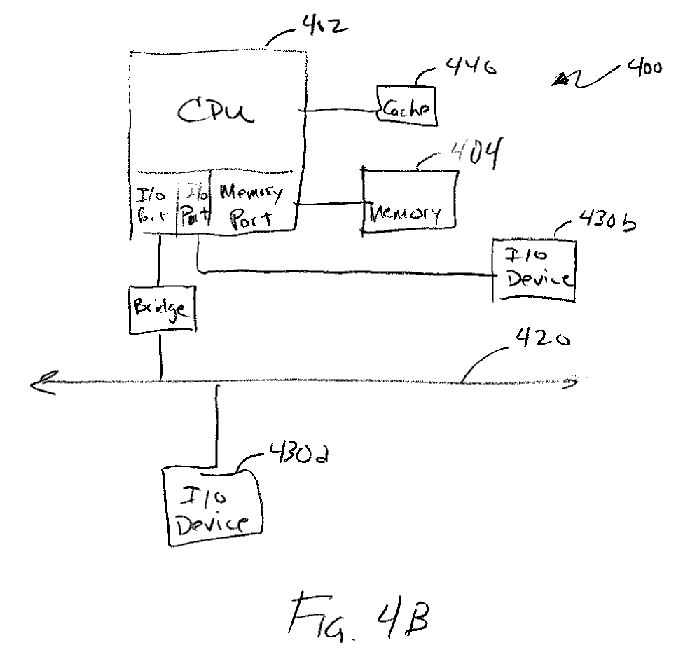

FIGS. 4A and 4B depict block diagrams of a typical computer 400 useful in connection with the present invention. As shown in FIGS. 4A and 4B, each computer 400 includes a central processing unit 402, and a main memory unit 404. Each computer 400 may also include other optional elements, such as one or more input/output devices 430a-430n (generally referred to using reference numeral 430), and a cache memory 440 in communication with the central processing unit 402. In the present invention, a camera is one of the input/output devices 430. The camera captures digital video image data and transfers the captured video image data to the main memory 404 via the system bus 420.

Various busses may be used to connect the camera to the processor 402, including a VESA VL bus, an ISA bus, an EISA bus, a MicroChannel Architecture (MCA) bus, a PCI bus, a PCI-X bus, a PCI-Express bus, or a NuBus. In these embodiments, the camera typically communicates with the local system bus 420 via another I/O device 430 which serves as a bridge between the system bus 420 and an external communication bus used by the camera, such as a Universal Serial Bus (USB), an Apple Desktop Bus (ADB), an RS-232 serial connection, a SCSI bus, a FireWire bus, a FireWire 800 bus, an Ethernet bus, or an AppleTalk bus.

FIG. 4B depicts an embodiment of a computer system 400 in which an I/O device 430b, such as the camera, communicates directly with the central processing unit 402 via HyperTransport, Rapid I/O, or InfiniBand. FIG. 4B also depicts an embodiment in which local busses and direct communication are mixed: the processor 402 communicates with I/O device 430a using a local interconnect bus while communicating with I/O device 430b directly.

The central processing unit 402 processes the captured video image data as described above. For embodiments in which the captured video image data is stored in the main memory unit 404, the central processing unit 402 retrieves data from the main memory unit 404 via the local system bus 420 in order to process it. For embodiments in which the camera communicates directly with the central processing unit 402, such as those depicted in FIG. 4B, the processor 402 stores captured image data and processes it. The processor 402 also identifies game player gestures and movements from the captured video image data and performs the duties of the game engine 340. The central processing unit 402 is any logic circuitry that responds to and processes instructions fetched from the main memory unit 404. In many embodiments, the central processing unit is provided by a microprocessor unit, such as: the 8088, the 80286, the 80386, the 80486, the Pentium, Pentium Pro, the Pentium II, the Celeron, or the Xeon processor, all of which are manufactured by Intel Corporation of Mountain View, Calif.; the 68000, the 68010, the 68020, the 68030, the 68040, the PowerPC 601, the PowerPC604, the PowerPC604e, the MPC603e, the MPC603ei, the MPC603ev, the MPC603r, the MPC603p, the MPC740, the MPC745, the MPC750, the MPC755, the MPC7400, the MPC7410, the MPC7441, the MPC7445, the MPC7447, the MPC7450, the MPC7451, the MPC7455, the MPC7457 processor, all of which are manufactured by Motorola Corporation of Schaumburg, Ill.; the Crusoe TM5800, the Crusoe TM5600, the Crusoe TM5500, the Crusoe TM5400, the Efficeon TM8600, the Efficeon TM8300, or the Efficeon TM8620 processor, manufactured by Transmeta Corporation of Santa Clara, Calif.; the RS/6000 processor, the RS64, the RS 64 II, the P2SC, the POWER3, the RS64 III, the POWER3-II, the RS 64 IV, the POWER4, the POWER4+, the POWER5, or the POWER6 processor, all of which are manufactured by International Business Machines of White Plains, N.Y.; or the AMD Opteron, the AMD Athalon 64 FX, the AMD Athalon, or the AMD Duron processor, manufactured by Advanced Micro Devices of Sunnyvale, Calif.

Main memory unit 404 may be one or more memory chips capable of storing data and allowing any storage location to be directly accessed by the central processor 402, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM).

In these embodiments, the computer 400 may include a specialized graphics subsystem, such as a video card, for communicating with the display. Video cards useful in connection with the present invention include the Radeon 9800 XT, the Radeon 9800 Pro, the Radeon 9800, the Radeon 9600 XT, the Radeon 9600 Pro, the Radeon 9600, the Radeon 9200 PRO, the Radeon 9200 SE, the Radeon 9200, and the Radeon 9700, all of which are manufactured by ATI Technologies, Inc. of Ontario, Canada. In some embodiments, the processor 202 may use an Advanced Graphics Port (AGP) to communicate with specialized graphics subsystems.

General-purpose desktop computers of the sort depicted in FIGS. 2A and 2B typically operate under the control of operating systems, which control scheduling of tasks and access to system resources. Typical operating systems include: MICROSOFT WINDOWS, manufactured by Microsoft Corp. of Redmond, Wash.; MacOS, manufactured by Apple Computer of Cupertino, Calif.; OS/2, manufactured by International Business Machines of Armonk, N.Y.: and Linux, a freely-available operating system distributed by Caldera Corp. of Salt Lake City, Utah, among others.

### EXAMPLE 1

In a first exemplary embodiment, the present invention is used to provide a sports action game in which a player controls a character riding a hoverboard, that is, a device that looks like a surfboard but can travel through the air. In some embodiments, gameplay is broken down in to three distinct modes: navigation, “rail-grinding,” and airborne gameplay.

In “rail-grinding” mode, the player controls the game character riding the hoverboard on a narrow rail. If the player raises his head, the game character assumes an erect position on the hoverboard. If the player lowers his head, the game character crouches on the hoverboard. A rapid acceleration of the player's head in an upward direction causes the game character to execute a jump maneuver with the hoverboard. If the player leans to the right or left, i.e. displaces his head to the right or left, the game character leans to the right or left on the hoverboard. In this gameplay mode, the game character's hands track the movement of the game player's hands. This allows the player to make the game character reach out to slap targets or to grab game elements positioned near the rail on which the player causes the game character to ride.

In navigation mode, the player controls the game character to move through the game environment on the hoverboard. If the player raises his head, the game character assumes an erect position on the hoverboard and the game character's acceleration slows. If the player lowers his head, the game character crouches on the hoverboard and the game character's acceleration increases. A rapid acceleration of the player's head in an upward direction causes the game character to execute a jump maneuver with the hoverboard. If the player leans to the right or left, i.e. displaces his head to the right or left, the game character leans to the right or left on the hoverboard. In this gameplay mode, leaning to the right or left also causes the game character to turn to the right or left on the hoverboard. During a “rail-grinding” session, the game character's hands track the movement of the game player's hands cause the game character to experience “drag,” which slows the velocity of the game character on the hoverboard. In some embodiments, the further from the body the player positions his hands, the more drag the game character experiences. In one particular embodiment, holding the left hand away from the body while leaving the right hand near the body causes the game character to execute a “power slide” to the left. Similarly, holding the right hand away from the body while leaving the left hand near the body causes the game character to execute a “power slide” to the right. If the game player holds both hands away from his body, the game character is caused to slow to a stop.

In this exemplary game, the player can cause the game character to “go airborne.” While airborne, the player can cause the character to steer left and right by leaning left or right. Also, the player can causes the game character to steer up or down by crouching or rising. This may also work in reverse, that is, crouching may cause the game character to steer down and rising to an erect position causes the character to steer up. Also, while airborne, the player can cause the character to perform tricks on the hoverboard such as spins, rolls, and tumbles, the direction of which can be controlled by the direction of the player's hands. The player causes the character to execute a spin by moving both hands either to the left or right of his body. The player causes the character to execute a tumble by raising or lowering both hands. The player causes the character to execute a roll by raising one arm while lowering the other.

### EXAMPLE 2

In another example, the system and methods described above may be used to provide a martial arts fighting game. In this game, the system tracks the location and motion of the player's arms, legs, and head. In this example, the player can cause the game character to jump or crouch by raising or lowering his head. The player causes the game character to punch by rapidly extending his hands. Similarly, the player causes the character to kick by rapidly extending his legs.

The game character can be caused to perform “combination moves.” For example, the player can cause the game character to perform a flying kick by raising his head and rapidly extending his leg at the same time. Similarly, the game character can be controlled to perform a flying punch by rapidly raising his head and rapidly extending his arm at the same time. In a similar manner, a sweep kick is performed by the character when the game player rapidly lowers his head and rapidly extends his leg at the same time.

### EXAMPLE 3

In this example, the described systems and methods are used to provide a boxing game. The system tracks the game player's head, hands, and torso. The game character punches when the game player punches. The player can cause the game character to duck punches by ducking, or to avoid punches by moving his torso and head rapidly to one side in an evasive manner.

### EXAMPLE 4

In this example, the described system and methods are used to provide a fantasy game. In one embodiment, the game player controls a wizard, whose arm motions follow those of the player. In these embodiments, the particular spell cast by the wizard is controlled by motion of the player's hands. Circular motion of the player's hands causes the wizard to move his hands in a circular motion and cast a spell shielding the wizard from damage. The player clapping his hands together causes the wizard to clap his hands to cast a spell crushing any other game characters in the wizard's line-of-sight. Raising one of the player's hands while lowering the other causes the wizard to do the same and cast a spell that makes all other game characters in the wizard's line-of-sight to lose their balance. When the player rapidly moves his hands directly out from his body, the wizard casts a fireball spell in the direction in which the player stretched his hands.

In another embodiment, the system can be used to control a warrior in the fantasy game. In this embodiment, the player's hands are tracked to determine when and how the warrior swings, or stabs, his sword. The warrior's arm motions track those of the player. In some embodiments, the player may be provided with a prop sword to provide enhanced verisimilitude to player's actions.

### EXAMPLE 5

In another example, the described systems and methods are used to provide a game in which the controlled character is a sniper. In this example, the system tracks the location of the player's arms and the motion of at least one of the player's fingers. Motion of the player's arms causes the character to aim the sniper rifle. Similarly, a rapid jerking motion of the player's finger causes the onscreen sniper to fire the weapon.

### EXAMPLE 6

In another example, the described systems and methods are used to provide a music rhythm game in which the controlled character is a musician. In one example, the controlled character is a guitarist and the player attempts to have the guitarist play chords or riffs in synchronicity or near-synchronicity with indications from the game that a chord or riff is to be played. The system tracks the location of the player's arms and hands and motion of the characters arms and hands track those of the player. Movement of the player's strumming hand causes the guitar character to strum the virtual guitar and play chords. In some embodiments the system can track the location of the player's chord hand to both adjust the location of the character's chord hand as well as determine if a higher or lower chord should be played. Similarly, the player can cause the guitarist to execute “moves” during game play, such as windmills, etc.

The present invention may be provided as one or more computer-readable programs embodied on or in one or more articles of manufacture. The article of manufacture may be a floppy disk, a hard disk, a compact disc, a digital versatile disc, a flash memory card, a PROM, a RAM, a ROM, or a magnetic tape. In general, the computer-readable programs may be implemented in any programming language. Some examples of languages that can be used include C, C++, C#, or JAVA. The software programs may be stored on or in one or more articles of manufacture as object code.

While the invention has been shown and described with reference to specific preferred embodiments, it should be understood by those skilled in the art that various changes in form and detail may be made therein without departing from the spirit and scope of the invention as defined by the following claims.

1. A method for allowing a player of a video game to control a three-dimensional game character in a three-dimensional game world, the method comprising the steps of:
acquiring video image data of a player of a game;
analyzing the acquired video image data to identify the location of a portion of the player's body; and
using the identified location of the portion of the player's body to control behavior of a game character.

2. The method of claim 1 wherein step (b) further comprises identifying the location of the player's head.

3. The method of claim 2 wherein step (b) further comprises identifying the location of the player's hands.

4. The method of claim 2 wherein step (b) further comprises identifying the location of the player's feet.

5. The method of claim 2 wherein step (b) further comprises identifying the location of the player's torso.

6. The method of claim 2 wherein step (b) further comprises identifying the location of the player's legs.

7. The method of claim 2 wherein step (b) further comprises identifying the location of the player's arms.

8. The method of claim 2 wherein step (c) comprises steering a game character in a rightward direction when the player's head leans to the right.

9. The method of claim 2 wherein step (c) comprises steering a game character in a leftward direction when the player's head leans to the left.

10. The method of claim 2 wherein step (c) comprises steering a game character in an upward direction when the player's head is raised.

11. The method of claim 2 wherein step (c) comprises steering a game character in a upward direction when the player's head is lowered.

12. The method of claim 2 wherein step (c) comprises steering a game character in an downward direction when the player's head is raised.

13. The method of claim 2 wherein step (c) comprises steering a game character in a downward direction when the player's head is lowered.

14. The method of claim 2 wherein step (c) comprises causing a game character to crouch when the player's head is lowered.

15. The method of claim 2 wherein step (c) comprises causing a game character to assume an erect position when the player's head is raised.

16. The method of claim 2 wherein step (c) comprises causing a game character to jump when the player's head rises rapidly.

17. The method of claim 2 wherein step (c) comprises leaning a game character to the left when the player's head leans to the left.

18. The method of claim 2 wherein step (c) comprises leaning a game character to the right when the player's head leans to the right.

19. The method of claim 2 wherein step (c) comprises accelerating a game character when the player's head is lowered.

20. The method of claim 2 wherein step (c) comprises decelerating a game character when the player's head is raised.

21. The method of claim 1 wherein step (b) further comprises identifying the location of the player's hands.

22. The method of claim 21 wherein step (b) further comprises identifying the location of the player's feet.

23. The method of claim 21 wherein step (b) further comprises identifying the location of the player's torso.

24. The method of claim 21 wherein step (b) further comprises identifying the location of the player's legs.

25. The method of claim 21 wherein step (b) further comprises identifying the location of the player's arms.

26. The method of claim 21 wherein step (c) comprises decelerating a game character when the player's hands are held away from the player's body.

27. The method of claim 21 wherein step (c) comprises raising a game character's left hand when the player's left hand is raised.

28. The method of claim 21 wherein step (c) comprises raising a game character's right hand when the player's right hand is raised.

29. The method of claim 21 wherein step (c) comprises accelerating a game character when the distance between the game player's body and hand decreases.

30. The method of claim 21 wherein step (c) comprises decelerating a game character when the distance between the game player's body and hand increases.

31. The method of claim 21 wherein step (c) comprises turning a game character to the left when the distance between the player's left hand and body increases.

32. The method of claim 21 wherein step (c) comprises turning a game character to the right when the distance between the player's right hand and body increases.

33. The method of claim 1 wherein step (b) further comprises identifying the location of the player's feet.

34. The method of claim 33 wherein step (b) further comprises identifying the location of the player's torso.

35. The method of claim 33 wherein step (b) further comprises identifying the location of the player's legs.

36. The method of claim 33 wherein step (b) further comprises identifying the location of the player's arms.

37. The method of claim 1 wherein step (b) further comprises identifying the location of the player's torso.

38. The method of claim 37 wherein step (b) further comprises identifying the location of the player's legs.

39. The method of claim 37 wherein step (b) further comprises identifying the location of the player's arms.

40. The method of claim 1 wherein step (b) further comprises identifying the location of the player's legs.

41. The method of claim 40 wherein step (b) further comprises identifying the location of the player's arms.

42. The method of claim 1 further comprising the step of analyzing the acquired video image data to determine a gesture made by the player.

43. The method of claim 42 further comprising the step of controlling the game character responsive to the determined gesture.

44. The method of claim 42 further comprising the step of spinning the game character clockwise in response to the gesture.

45. The method of claim 42 further comprising the step of spinning the game character counter-clockwise in response to the gesture.

46. A system for allowing a player of a video game to control a three-dimensional game character in a three-dimensional game world, the system comprising:
an image acquisition subsystem acquiring video image data of a player of a game;
an analysis engine identifying the location of a portion of the player's body; and
a translation engine using the identified location of the portion of the player's body to control behavior of a game character.

47. The system of claim 46 wherein said analysis engine identifies the location of the player's head.

48. The system of claim 47 wherein said analysis engine identifies the location of the player's hands.

49. The system of claim 47 wherein said analysis engine identifies the location of the player's feet.

50. The system of claim 47 wherein said analysis engine identifies the location of the player's torso.

51. The system of claim 47 wherein said analysis engine identifies the location of the player's legs.

52. The system of claim 47 wherein said analysis engine identifies the location of the player's arms.

53. The system of claim 47 wherein said translation engine outputs signals indicative of steering a game character in a rightward direction when the player's head leans to the right.

54. The system of claim 47 wherein said translation engine outputs signals indicative of steering a game character in a leftward direction when the player's head leans to the left.

55. The system of claim 47 wherein said translation engine outputs signals indicative of steering a game character in an upward direction when the player's head is raised.

56. The system of claim 47 wherein said translation engine outputs signals indicative of steering a game character in a upward direction when the player's head is lowered.

57. The system of claim 47 wherein said translation engine outputs signals indicative of steering a game character in an downward direction when the player's head is raised.

58. The system of claim 47 wherein said translation engine outputs signals indicative of steering a game character in a downward direction when the player's head is lowered.

59. The system of claim 47 wherein said translation engine outputs signals indicative of causing a game character to crouch when the player's head is lowered.

60. The system of claim 47 wherein said translation engine outputs signals indicative of causing a game character to assume an erect position when the player's head is raised.

61. The system of claim 47 wherein said translation engine outputs signals indicative of causing a game character to jump when the player's head rises rapidly.

62. The system of claim 47 wherein said translation engine outputs signals indicative of leaning a game character to the left when the player's head leans to the left.

63. The system of claim 47 wherein said translation engine outputs signals indicative of leaning a game character to the right when the player's head leans to the right.

64. The system of claim 47 wherein said translation engine outputs signals indicative of accelerating a game character when the player's head is lowered.

65. The system of claim 47 wherein said translation engine outputs signals indicative of decelerating a game character when the player's head is raised.

66. The system of claim 46 wherein said analysis engine identifies the location of the player's hands.

67. The system of claim 66 wherein said analysis engine identifies the location of the player's feet.

68. The system of claim 66 wherein said analysis engine identifies the location of the player's torso.

69. The system of claim 66 wherein said analysis engine identifies the location of the player's legs.

70. The system of claim 66 wherein said analysis engine identifies the location of the player's arms.

71. The system of claim 66 wherein said translation engine outputs signals indicative of decelerating a game character when the player's hands are held away from the player's body.

72. The system of claim 66 wherein said translation engine outputs signals indicative of raising a game character's left hand when the player's left hand is raised.

73. The system of claim 66 wherein said translation engine outputs signals indicative of raising a game character's right hand when the player's right hand is raised.

74. The system of claim 66 wherein said translation engine outputs signals indicative of accelerating a game character when the distance between the game player's body and hand decreases.

75. The system of claim 66 wherein said translation engine outputs signals indicative of decelerating a game character when the distance between the game player's body and hand increases.

76. The system of claim 66 wherein said translation engine outputs signals indicative of turning a game character to the left when the distance between the player's left hand and body increases.

77. The system of claim 66 wherein said translation engine outputs signals indicative of turning a game character to the right when the distance between the player's right hand and body increases.

78. The system of claim 46 wherein said analysis engine identifies the location of the player's feet.

79. The system of claim 78 wherein said analysis engine identifies the location of the player's torso.

80. The system of claim 78 wherein said analysis engine identifies the location of the player's arms.

81. The system of claim 78 wherein said analysis engine identifies the location of the player's legs.

82. The system of claim 46 wherein said analysis engine identifies the location of the player's torso.

83. The system of claim 82 wherein said analysis engine identifies the location of the player's arms.

84. The system of claim 82 wherein said analysis engine identifies the location of the player's legs.

85. The system of claim 46 wherein said analysis engine identifies the location of the player's arms.

86. The system of claim 46 wherein said analysis engine identifies the location of the player's legs.

87. The system of claim 46 wherein said analysis engine determines a gesture made by the player.

88. The system of claim 87 wherein said translation engine outputs signals indicative for controlling the game character responsive to the determined gesture.

89. The system of claim 87 wherein said translation engine outputs signals indicative of spinning the game character clockwise in response to the gesture.

90. The system of claim 87 wherein said translation engine outputs signals indicative of spinning the game character counter-clockwise in response to the gesture.
